(19) United States
(12) Patent Application Publication
(10) Pub. No.: US 2026/0061764 A1
(43) Pub. Date: Mar. 5, 2026

(54) PRINTING DEVICE

(71) Applicant: SEIKO EPSON CORPORATION, Tokyo (JP)

(72) Inventor: Hiroyuki NAKAYAMA, SHIOJIRI-SHI (JP)

(21) Appl. No.: 19/316,589

(22) Filed: Sep. 2, 2025

(30) Foreign Application Priority Data
Sep. 3, 2024 (JP) 2024-151647

(51) Int. Cl. B41J 29/13; B41J 3/46; B41J 29/17

(52) U.S. Cl. CPC B41J 29/13; B41J 3/46; B41J 29/17

(57) ABSTRACT

A printing device 1 includes a printing section 5 configured to print on a medium; a housing 100 that configured to house the printing section 5; an opening and closing cover 200 configured to open and close a part of the housing 100; and an operation panel 300 provided side by side with the opening and closing cover 200 in an alignment direction in a state where the opening and closing cover 200 is closed, wherein the opening and closing cover 200 has a first wall 201 having a pivot shaft 203 extending in the alignment direction and being a part of a wall 100A on the first direction side of the housing 100, and a second wall 202 that is a part of a wall 100B on the second direction side of the housing 100 and a contact section 210 is provided on an inner surface of the second wall 202 of the opening and closing cover 200, and is configured to contact the contacted section 110 when the opening and closing cover 200 is closed, thereby displacing the opening and closing cover 200 separates from the operation panel 300.

The present application is based on, and claims priority from JP Application Serial Number 2024-151647, filed Sep. 3, 2024, the disclosure of which is hereby incorporated by reference herein in its entirety.

### BACKGROUND

### 1. Technical Field

The present disclosure relates to a printing device.

### 2. Related Art

In the related art, various printing devices have been used. Among these, there is a printing device having a configuration in which an opening and closing cover and an operation panel are provided side by side. For example, JP-A-2020-104426 discloses a liquid ejecting device having a configuration in which an openable and closable maintenance cover and an operation panel are provided side by side.

In the printing device of the related art having a configuration in which the opening and closing cover and the operation panel are provided side by side, when the opening and closing cover is opened and closed, the opening and closing cover may be twisted due to a weight difference between the left and right sides, and a part of the opening and closing cover may contact the adjacent operation panel. When a part of the opening and closing cover contacts the operation panel, the operation panel may be damaged. For example, in a configuration in which a maintenance cover is provided as an opening and closing cover as in the liquid ejecting device of JP-A-2020-104426, the maintenance cover tends to increase in size for ease of maintenance work, and there are cases in which twisting or the like is likely to occur.

### SUMMARY

A printing device according to the present disclosure for solving the above problem, the printing device includes a printing section configured to print on a medium; a housing configured to house the printing section; an opening and closing cover configured to open and close a part of the housing; and an operation panel provided side by side with the opening and closing cover in an alignment direction in a state where the opening and closing cover is closed, wherein the opening and closing cover has a first wall that is a part of a wall of the housing on a first direction side and a second wall that is a part of a wall of the housing on a second direction side that intersects with the first wall, and is opened and closed by pivoting around a pivot shaft that is provided on the first wall and that extends in the alignment direction and a contact section is provided on an inner surface of the second wall of the opening and closing cover and, by contacting a part of the housing or a contacted section provided inside the housing when the opening and closing cover is closed, the contact section displaces the opening and closing cover so that the opening and closing cover separates from the operation panel.

### BRIEF DESCRIPTION OF THE DRAWINGS

FIG. 1 is a schematic perspective view of a printing device according to an embodiment of the present disclosure.

FIG. 2 is a perspective view showing a periphery of an opening and closing cover of the printing device in FIG. 1.

FIG. 3 is a perspective view showing the periphery of the opening and closing cover of the printing device in FIG. 1, as viewed from an angle different from that in FIG. 2.

FIG. 4 is a perspective view showing the opening and closing cover of the printing device in FIG. 1.

FIG. 5 is a front view showing the periphery of the opening and closing cover of the printing device in FIG. 1.

FIG. 6 is a perspective view showing the periphery of the opening and closing cover of the printing device in FIG. 1, as viewed from an angle different from those in FIG. 2 and FIG. 3.

### DESCRIPTION OF EMBODIMENTS

First, the present disclosure will be schematically described.

A printing device includes a printing section configured to print on a medium; a housing configured to house the printing section; an opening and closing cover configured to open and close a part of the housing; and an operation panel provided side by side with the opening and closing cover in an alignment direction in a state where the opening and closing cover is closed, wherein the opening and closing cover has a first wall that is a part of a wall of the housing on a first direction side and a second wall that is a part of a wall of the housing on a second direction side that intersects with the first wall, and is opened and closed by pivoting around a pivot shaft that is provided on the first wall and that extends in the alignment direction and a contact section is provided on an inner surface of the second wall of the opening and closing cover and, by contacting a part of the housing or a contacted section provided inside the housing when the opening and closing cover is closed, the contact section displaces the opening and closing cover so that the opening and closing cover separates from the operation panel.

According to the present aspect, the contact section is provided on the opening and closing cover and, by contacting the contacted section when the opening and closing cover is closed, the contact section displaces the opening and closing cover separates from the operation panel. Therefore, when the opening and closing cover is closed, the opening and closing cover provided side by side with the operation panel can be prevented from contacting the operation panel.

A second aspect of the printing device is an aspect according to the first aspect, wherein the wall of the housing on the second direction side has an opening section that widens further than the position of the printing section in an opposite direction to the first direction and the opening and closing cover is configured to cover the opening section.

According to the present aspect, the wall of the housing on the second direction side has the opening section that widens further than the position of the printing section in the opposite direction to the first direction. By configuring the opening section in this way, the opening section can be made larger, and the efficiency of the work performed by opening section the opening and closing cover can be improved. The opening and closing cover is configured to be able to cover the opening section. The opening and closing cover having such a configuration is generally large and is likely to be twisted, but the contact section is provided on the opening and closing cover and, by contacting the contacted section when the opening and closing cover is closed, the contact section displaces the opening and closing cover separates from the operation panel, and thus, when the opening and closing cover is closed, the opening and closing cover provided side by side with the operation panel can be prevented from contacting the operation panel.

A third aspect of the printing device is an aspect according to the first aspect, wherein the opening and closing cover is made of resin.

According to the present aspect, the opening and closing cover is made of resin. With such a configuration, the opening and closing cover can be made light, and the efficiency of the work performed by opening section the opening and closing cover can be improved. Note that, although the opening and closing cover having such a configuration is generally large and is likely to be twisted, but the contact section is provided on the opening and closing cover and, by contacting the contacted section when the opening and closing cover is closed, the contact section displaces the opening and closing cover separates from the operation panel, and thus, when the opening and closing cover is closed, the opening and closing cover provided side by side with the operation panel can be prevented from contacting the operation panel.

A fourth aspect of the printing device is an aspect according to the first aspect, wherein the second wall has a thickness of a second portion farther from the first wall smaller than a thickness of a first portion closer to the first wall.

According to the present aspect, the second wall has a thickness of the second portion farther from the first wall smaller than a thickness of the first portion closer to the first wall. With such a configuration, the opening and closing cover can be easily opened and closed.

A fifth aspect of the printing device is an aspect according to the first aspect, wherein the contact section is a protruding section that protrudes in a direction toward the contacted section in a state where the opening and closing cover is closed.

According to the present aspect, the contact section is a protruding section that protrudes in a direction toward the contacted section in a state where the opening and closing cover is closed. With such a configuration, the contact section can be simply configured.

A sixth aspect of the printing device is an aspect according to the fifth aspect, wherein the protruding section is a plate-shaped section extending in a tangential direction of an arc centered on the pivot shaft.

According to the present aspect, the protruding section is a plate-shaped section extending in the tangential direction of an arc centered on the pivot shaft. With such a configuration, the contact section and the contacted section can be brought into contact with each other with high accuracy as the opening and closing cover is closed. Therefore, when the opening and closing cover is closed, the opening and closing cover provided side by side with the operation panel can be particularly effectively prevented from contacting the operation panel.

A seventh aspect of the printing device is an aspect according to the sixth aspect, wherein an end section of the plate-shaped section in the tangential direction has a tapered shape.

According to the present aspect, the end section of the plate-shaped section in the tangential direction has a tapered shape. With such a configuration, it is possible to prevent the contact section and the contacted section from getting caught when, for example, the contact section and the contacted section are in contact with each other as the opening and closing cover is closed. Therefore, it is possible to suppress the occurrence of opening and closing failure of the opening and closing cover.

An eighth aspect of the printing device is an aspect according to the first aspect, further includes a maintenance unit, wherein the opening and closing cover is configured to cover the maintenance unit in a closed state.

According to the present aspect, the maintenance unit is provided. With such a configuration, the printing device can be kept in a suitable state. The opening and closing cover is configured to cover the maintenance unit in a closed state. By adopting such a configuration and using the opening and closing cover as a maintenance cover, it is conceivable to enlarge the opening and closing cover in order to facilitate maintenance work. However, even if the opening and closing cover is increased in size, but the contact section is provided on the opening and closing cover and, by contacting the contacted section when the opening and closing cover is closed, the contact section displaces the opening and closing cover separates from the operation panel, and thus, when the opening and closing cover is closed, the opening and closing cover provided side by side with the operation panel can be prevented from contacting the operation panel.

A ninth aspect of the printing device is an aspect according to the first aspect, wherein the second wall is provided on an opposite side of the operation panel in the alignment direction.

According to the present aspect, the second wall is provided on the opposite side of the operation panel in the alignment direction. With such a configuration, when the opening and closing cover is closed, the opening and closing cover provided side by side with the operation panel can be particularly effectively prevented from contacting the operation panel.

Hereinafter, embodiments according to the present disclosure will be described in detail with reference to the drawings. Here, in each drawing, an X-axis direction in the drawing is a horizontal direction and is a width direction of a printing device 1, a Y-axis direction is the horizontal direction and is a front-rear direction of the printing device 1 and is a direction orthogonal to the X-axis direction, and a Z-axis direction is a vertical direction. In the following description, a direction indicated by an arrow is defined as a + direction, and an opposite direction to the direction indicated by the arrow is defined as a − direction. For example, the vertically upward direction is a +Z direction, the vertically downward direction is a −Z direction, the front surface direction of the printing device 1 is a +Y direction, and the rear surface direction of the printing device 1 is a −Y direction.

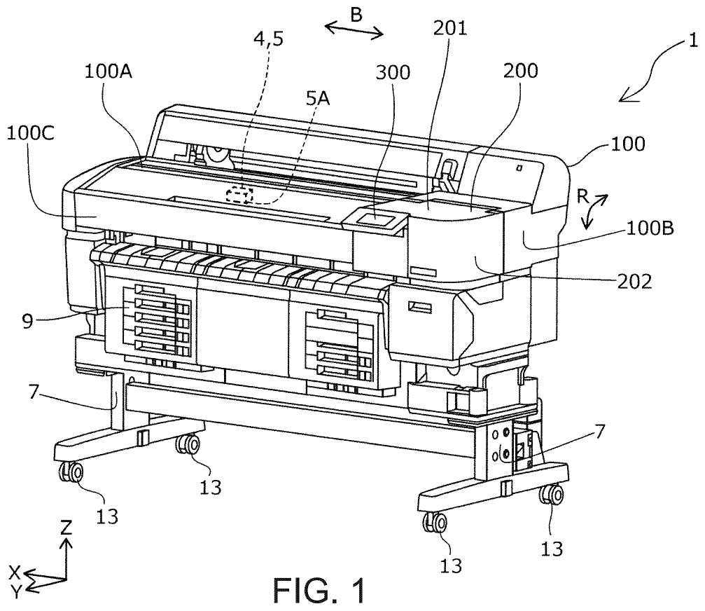

As shown in FIG. 1, the printing device 1 of the present embodiment includes a housing 100, and leg frames 7 are attached to the housing 100 in the vicinity portion of both ends in the X-axis direction. Casters 13 are provided below the leg frames 7, and the printing device 1 can be easily moved by using the casters 13. The printing device 1 of the present embodiment includes a medium feeding section (not shown) that holds a medium wound in a roll shape inside the housing 100. The medium feeding section feeds medium to a position facing an ink ejection surface 5A of a head 5 as a printing section.

At the position where a wall 100A on a first direction side (+Z direction side) of the housing 100, a wall 100B on a second direction side (−X direction side) of the housing 100, and a wall 100C on a third direction side (+Y direction side) of the housing 100 are connected, an opening and closing cover 200 is provided, which constitutes a part of the wall 100A and a part of the wall 100B. The configuration of the opening and closing cover 200 and the configuration inside the opening and closing cover 200 will be described later. An operation panel 300 is provided in the vicinity of the opening and closing cover 200, and an operation surface of the operation panel 300 and the wall 100A are positioned at substantially the same height. The operation surface of the operation panel 300 is mainly directed in the +Z direction, but the direction of the operation surface may be changeable. The operation panel 300 of the present embodiment is configured by a display device including a touch panel. Therefore, the operation surface of the operation panel 300 is also a display surface, and various kinds of information are displayed thereon.

The printing device 1 of the present embodiment includes the head 5 as a printing section that is provided with plurality of nozzles in the ink ejection surface 5A and that ejects liquid ink from the nozzles to form an image, and a carriage 4 that is capable of reciprocating in a width direction B with the head 5 mounted thereon. That is, the width direction B corresponds to a scanning direction of the carriage 4. A liquid supply path (not shown) formed of a tube or the like is connected to the head 5, and ink is supplied to the head 5 from a plurality of ink cartridges (not shown) mounted on an ink cartridge mounting section 9 via the liquid supply path (not shown). In the printing device 1 of the present embodiment, a transport direction of the medium at the position facing the ink ejection surface 5A is the +Y direction, a movement direction of the head 5, that is, the width direction B, which is the scanning direction of the carriage 4, is the direction along the X-axis direction, and an ejection direction of the ink is the −Z direction.

With the above described configuration, the head 5 can form an image by ejecting ink, which is a liquid, from the nozzles (not shown) onto the medium being transported, while reciprocating in the width direction B, which is a direction intersecting the transport direction of the medium. The printing device 1 of the present embodiment is capable of forming a desired image on the medium by repeatedly transporting the medium a predetermined transport amount and ejecting ink while moving the head 5 in the width direction B while the medium is stopped. However, it is not limited to such a configuration, and a configuration including a so-called line head in which nozzles that ejecting the ink along the width direction B are arranged over the entire width of the medium may be adopted.

As described above, the printing device 1 of the present embodiment includes the head 5 that performs printing on the medium, and the housing 100 that houses the head 5. As shown in FIG. 1, it includes the opening and closing cover 200 that opens and closes a part of the housing 100, and the operation panel 300 that is provided side by side with the opening and closing cover 200 in the width direction B (alignment direction) in a state where the opening and closing cover 200 is closed. Hereinafter, a configuration of the opening and closing cover 200 and a configuration inside the opening and closing cover 200 will be described in detail. The expression “the operation panel 300 provided side by side with the opening and closing cover 200 in the width direction B (alignment direction) in a state where the opening and closing cover 200 is closed” means that at least a part of the opening and closing cover 200 and at least a part of the operation panel 300 may be provided side by side, and as described above, in the present embodiment, the alignment direction of the opening and closing cover 200 and the operation panel 300 corresponds to the width direction B (X-axis direction).

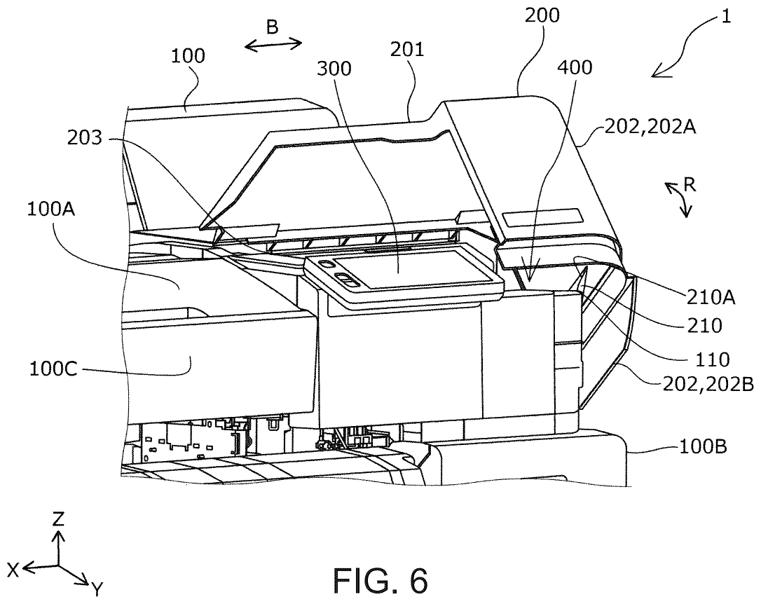

As shown in FIG. 1 to FIG. 6, the opening and closing cover 200 of the printing device 1 of the present embodiment has a first wall 201, which is a part of the wall 100A on a first direction side (+Z direction side) of the housing 100, and a second wall 202, which is a part of the wall 100B on a second direction side (−X direction side) intersecting the first wall 201 of the housing 100 and is provided on a side (−X direction side) opposite to the operation panel 300 in the width direction B. The opening and closing cover 200 of the present embodiment is opened and closed by being pivoted in a pivot direction R by a pivot shaft 203 provided on the first wall 201 and extending in the width direction B.

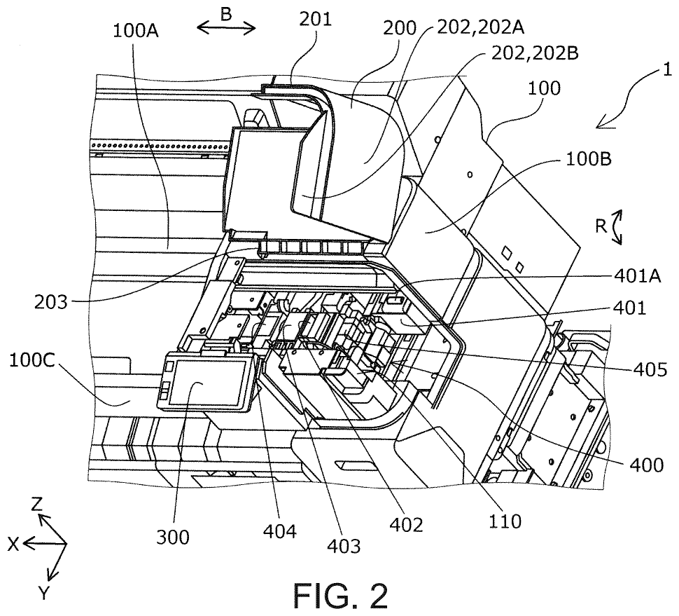

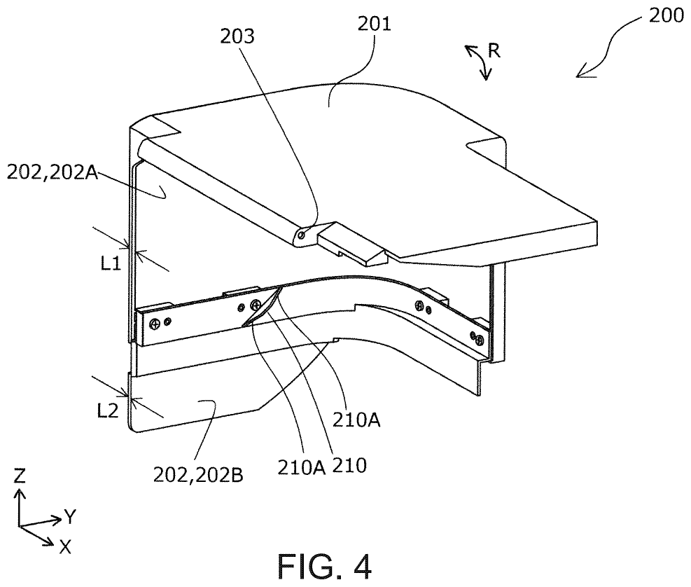

The opening and closing cover 200 of the present embodiment is provided with a contact section 210 shown in FIG. 4 to FIG. 6 on the inner surface of the second wall 202 of the opening and closing cover 200. As shown in FIG. 2 and the like, the housing 100 is provided with a contacted section 110 that contacts the contact section 210 when the opening and closing cover 200 is closed. Explained from another viewpoint, the contacted section 110 is provided in a part of the housing 100, and when the opening and closing cover 200 is closed, the contact section 210 presses the opening and closing cover 200 as a whole in the −X direction by contacting the contacted section 110, and displaces the opening and closing cover 200 separates from the operation panel 300. Explained from still another viewpoint, the printing device 1 of the present embodiment includes the contact section 210 at a position different from a portion of the opening and closing cover 200 that may contact the operation panel 300 so as to separate from the operation panel 300, and displaces the opening and closing cover 200 so as to separate away from the operation panel 300. Note that when there is no twisting of the opening and closing cover 200 at least in the direction of contact with the operation panel 300, it is desirable that the contact section 210 and the contacted section 110 are positioned so that they do not contact when the opening and closing cover 200 is opened or closed. The positions where the contact section 210 and the contacted section 110 are formed may be reversed, the contacted section 110 may be provided on the opening and closing cover 200, and the contact section 210 may be provided on a part of the housing 100.

Note that in the opening and closing cover 200 of the printing device 1 of the present embodiment, the second wall 202 provided with the contact section 210 is a part of the wall 100B on the −X direction side and is positioned on the opposite side (−X direction side) in the width direction B from where the operation panel 300 is disposed. However, the second wall 202 on which the contact section 210 is provided may be configured as a part of the wall 100C on the third direction side (+Y direction side) of the housing 100. However, it is desirable that the second wall 202 on which the contact section 210 is provided is positioned on the opposite side (−X direction side) in the width direction B from where the operation panel 300 is disposed. This is because the opening and closing cover 200 can be displaced separates from the operation panel 300 particularly effectively, and the opening and closing cover 200 can be prevented from contacting the operation panel 300 particularly effectively when the opening and closing cover 200 is closed. In the printing device 1 of the present embodiment, the contacted section 110 is provided in a part of the housing 100, but the configuration is not limited thereto, and the contacted section 110 may be provided inside the housing 100 as a component member different from the housing 100.

As described above, it is desirable that, the contact section 210 is provided on an inner surface of the second wall 202 of the opening and closing cover 200 and that the contact section 210 displaces the opening and closing cover 200 so that the opening and closing cover 200 separates from the operation panel 300 by the contact section 210 contacting a part of the housing 100 or the contacted section 110 provided inside the housing 100 when the opening and closing cover 200 is closed. With such a configuration, when the opening and closing cover 200 is closed, the opening and closing cover 200 provided side by side with the operation panel 300 can be prevented from contacting the operation panel 300.

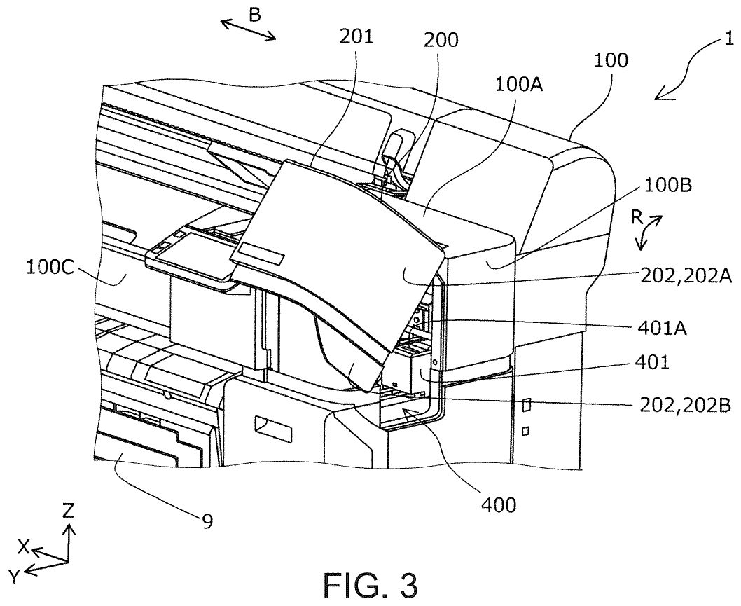

As shown in FIG. 2 and FIG. 3, in the printing device 1 of the present embodiment, a wide opening section 400 is exposed in the housing 100 by opening the opening and closing cover 200. The wall 100B on the second direction side (−X direction side) of the housing 100 constituting the opening section 400 extends deeper than the position of the head 5 in the −Z direction, which is the opposite direction to the first direction. Here, the opening and closing cover 200 is configured to be able to completely cover the opening section 400 as shown in FIG. 1 and the like.

As described above, since the wall 100B of the housing 100 on the second direction side has the opening section 400 that is wider than the position of the head 5 in the −Z direction, the opening section 400 can be made large, and the workability performed by opening the opening and closing cover 200 can be improved. When the opening and closing cover 200 is configured to be able to cover the deep opening section 400 and the opening and closing cover 200 is configured to be long in a depth direction, the opening and closing cover 200 is generally large and is likely to be twisted. However, by providing the opening and closing cover 200 with the contact section 210 that displaces the opening and closing cover 200 separates from the operation panel 300 by contacting the contacted section 110 when the opening and closing cover 200 is closed, it is possible to suppress the opening and closing cover 200 provided side by side with the operation panel 300 from contacting the operation panel 300 when the opening and closing cover 200 is closed.

Here, in the printing device 1 of the present embodiment, the opening and closing cover 200 is made of resin. In this manner, by configuring the opening and closing cover 200 to be made of resin, the opening and closing cover 200 can be configured to be light, and the efficiency of work performed by opening the opening and closing cover 200 can be improved.

Note that, although the opening and closing cover 200 made of resin is generally likely to be twisted, the opening and closing cover 200 provided side by side with the operation panel 300 can be prevented from contacting the operation panel 300 when the opening and closing cover 200 is closed, by providing the opening and closing cover 200 with the contact section 210 that displaces the opening and closing cover 200 separates from the operation panel 300 by the contact section 210 contacting the contacted section 110 when the opening and closing cover 200 is closed. Here, “the opening and closing cover 200 is made of resin” means that the opening and closing cover 200 may be configured using resin as a main material, and may include a material other than resin such as metal to some extent.

The inside of the opening and closing cover 200 is a standby position of the head 5 in a state of not performing printing, that is, a so-called home position of the head 5 and, as shown in FIG. 2, a cap 404 that covers the nozzles of the ink ejection surface 5A is provided at a position facing the ink ejection surface 5A when the head 5 is at the home position. A flushing box 403 for flushing is provided at a position adjacent to the cap 404 on the −X direction side, and a suction cap 402 for suctioning the nozzles of the ink ejection surface 5A is provided at a position adjacent to the flushing box 403 on the −X direction side. A deaeration unit 405 that removes air bubbles in the ink is provided at a position adjacent to the suction cap 402 on the −X direction side.

A cloth wiper 401 capable of wiping the ink ejection surface 5A is provided on the −X direction side of the deaeration unit 405. The cloth wiper 401 is movable along the Y-axis direction, and wipes the ink ejection surface 5A with a roll 401A of cloth wound in a roll shape while moving along the Y-axis direction. The home position of the cloth wiper 401 is on the −Y direction side of a movement range of the head 5, and when the opening and closing cover 200 is opened when the head 5 moves to the maximum on the −X direction side, the ink ejection surface 5A can be visually confirmed from the lower side through the opening section 400, and it is possible to perform an operation of cleaning the ink ejection surface 5A with a cotton swab or the like. In order to facilitate such an operation, the opening section 400 is opened to a deep position in the −Z direction. The opening and closing cover 200 is configured to open the opening section 400 that is widely open.

That is, the inside of the opening and closing cover 200 is the home position of the head 5 and a maintenance position for performing maintenance of the head 5. Explained from another viewpoint, the opening and closing cover 200 of the present embodiment is the maintenance cover that can be opened and closed when an operator performs maintenance of the head 5. By opening the opening and closing cover 200, the cloth wiper 401, the suction cap 402, the flushing box 403, the cap 404, the deaeration unit 405, and the like as the maintenance unit can be replaced and cleaned.

Explained from another viewpoint, the printing device 1 of the present embodiment includes the maintenance unit having the cloth wiper 401, the suction cap 402, the flushing box 403, the cap 404, the deaeration unit 405, and the like, and the opening and closing cover 200 is configured to cover the maintenance unit in the closed state. In this way, the printing device 1 can be kept in a suitable state by including the maintenance unit.

In the printing device 1 of the present embodiment, the opening and closing cover 200 is configured to cover the maintenance unit in the closed state, and the opening and closing cover 200 is increased in size in order to largely open a part of the housing 100 covering the maintenance unit when the opening and closing cover 200 is opened and to facilitate maintenance work. However, even if the opening and closing cover 200 is increased in size, as described above, the opening and closing cover 200 is provided with the contact section 210 that displaces the opening and closing cover 200 separates from the operation panel 300 by the contact section 210 contacting the contacted section 110 when the opening and closing cover 200 is closed, thereby it is a configuration that can prevent the opening and closing cover 200, which is provided side by side with the operation panel 300, from contacting the operation panel 300 when the opening and closing cover 200 is closed.

As described above, the opening and closing cover 200 of the present embodiment has the first wall 201 constituting a part of the wall 100A and the second wall 202 constituting a part of the wall 100B, and of these, the second wall 202 has a first portion 202A close to the wall 100A and a second portion 202B far from the wall 100A. In the second wall 202 of the printing device 1 of the present embodiment, as shown in FIG. 4, a thickness L2 of the second portion 202B is smaller than a thickness L1 of the first portion 202A. The printing device 1 of the present embodiment has such a configuration, and thus, it is possible to easily open and close the opening and closing cover 200. Note that as an embodiment in which “a thickness L2 of the second portion 202B is smaller than a thickness L1 of the first portion 202A”, a configuration in which the thickness gradually decreases from the first portion 202A to the second portion 202B may be adopted in addition to the configuration in which the first portion 202A and the second portion 202B are stepped.

Here, the shape of the contact section 210 of the present embodiment will be described in more detail. The contact section 210 of the present embodiment is a protruding section that protrudes in a direction toward the contacted section 110 in a state where the opening and closing cover 200 is closed. The contact section 210 of the present embodiment has such a configuration, and thus the contact section 210 can be simply configured.

Further, the contact section 210 of the present embodiment, which is a protruding section, is a plate-shaped section that is a plate-shaped component member extending in a tangential direction of an arc centered on the pivot shaft 203 of the opening and closing cover 200. With such a configuration, the contact section 210 of the present embodiment can bring the contact section 210 and the contacted section 110 in contact with each other with high accuracy as the opening and closing cover 200 is closed. Therefore, the contact section 210 of the present embodiment is configured to be able to particularly effectively suppress the opening and closing cover 200 provided side by side with the operation panel 300 from contacting the operation panel 300 when the opening and closing cover 200 is closed. In the present embodiment, the contact section 210 is provided on the inner surface of the second wall 202 so that the surface of the plate-shaped section extends intersecting the Y direction and the Z direction when the opening and closing cover 200 is closed.

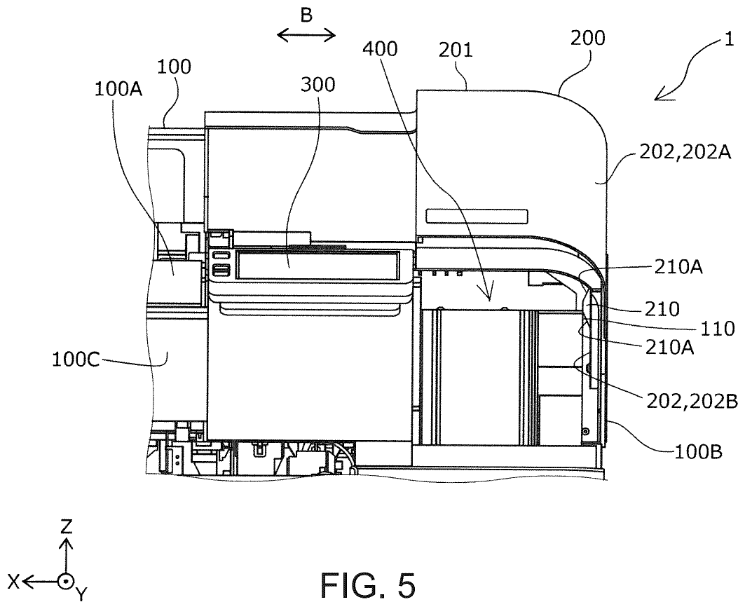

As shown in FIG. 4 and FIG. 5, the contact section 210 of the present embodiment, which is a plate-shaped section, has a tapered shape 210A at an end section in the tangential direction of an arc centered on the pivot shaft 203 of the opening and closing cover 200. The contact section 210 of the present embodiment is configured such that a portion near the center protrudes in a direction toward the contacted section 110 most with respect to the tangential direction of an arc centered on the pivot shaft 203, and the tapered shape 210A is disposed on both sides of the most protruding section. The contact section 210 of the present embodiment has such a configuration, and therefore, when the contact section 210 and the contacted section 110 are in contact with each other as the opening and closing cover 200 is closed, it is possible to suppress snagging between the contact section 210 and the contacted section 110. Therefore, the contact section 210 of the present embodiment is configured to be able to suppress the occurrence of opening and closing failure of the opening and closing cover 200.

In the printing device 1 of the present embodiment, the extension amount of the contacted section 110 in the −Z direction is adjusted to be short, and the contact between the contact section 210 and the contacted section 110 is configured to release in a state where the opening and closing cover 200 is completely closed. Therefore, when the opening and closing cover 200 is opened from the state where the opening and closing cover 200 is completely closed, the contact section 210 and the contacted section 110, which were in the non-contact state, are in contact with each other. Since the printing device 1 of the present embodiment has such a configuration, both end sections of the contact section 210 in the direction in which it extends are formed as the tapered shape 210A, and thus, it is possible to suppress the occurrence of opening and closing defects of the opening and closing cover 200 not only when the opening and closing cover 200 is closed but also when the opening and closing cover 200 is opened from a state where the opening and closing cover 200 is completely closed.

The present disclosure is not limited to the above described embodiments, and can be realized by various configurations without departing from the scope of the present disclosure. The features technical in the embodiments corresponding to the technical features in the aspects described in the section of the summary of the disclosure can be replaced or combined as appropriate in order to solve some or all of the above described problems or in order to achieve some or all of the above described effects. If the technical features are not described as essential in this specification, the technical features can be appropriately omitted.

What is claimed is:

1. A printing device comprising:
a printing section configured to print on a medium;
a housing configured to house the printing section;
an opening and closing cover configured to open and close a part of the housing; and
an operation panel provided side by side with the opening and closing cover in an alignment direction in a state where the opening and closing cover is closed, wherein
the opening and closing cover has a first wall that is a part of a wall of the housing on a first direction side and a second wall that is a part of a wall of the housing on a second direction side that intersects with the first wall, and is opened and closed by pivoting around a pivot shaft that is provided on the first wall and that extends in the alignment direction and
a contact section is provided on an inner surface of the second wall of the opening and closing cover and, by contacting a part of the housing or a contacted section provided inside the housing when the opening and closing cover is closed, the contact section displaces the opening and closing cover so that the opening and closing cover separates from the operation panel.

2. The printing device according to claim 1, wherein
the wall of the housing on the second direction side has an opening section that widens further than the position of the printing section in an opposite direction to the first direction and
the opening and closing cover is configured to cover the opening section.

3. The printing device according to claim 1, wherein
the opening and closing cover is made of resin.

4. The printing device according to claim 1, wherein
the second wall has a thickness of a second portion farther from the first wall smaller than a thickness of a first portion closer to the first wall.

5. The printing device according to claim 1, wherein
the contact section is a protruding section that protrudes in a direction toward the contacted section in a state where the opening and closing cover is closed.

6. The printing device according to claim 5, wherein
the protruding section is a plate-shaped section extending in a tangential direction of an arc centered on the pivot shaft.

7. The printing device according to claim 6, wherein
an end section of the plate-shaped section in the tangential direction has a tapered shape.

8. The printing device according to claim 1, further comprising:
a maintenance unit, wherein
the opening and closing cover is configured to cover the maintenance unit in a closed state.

9. The printing device according to claim 1, wherein
the second wall is provided on an opposite side of the operation panel in the alignment direction.
